(19) United States
(12) Patent Application Publication
(10) Pub. No.: US 2009/0258328 A1
(43) Pub. Date: Oct. 15, 2009

(54) 5 IN 1 DENTAL IMPLANT METHOD AND APPARATUS

(76) Inventor: Chun-Leon Chen, Las Vegas, NV (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/487,491

(22) Filed: Jun. 18, 2009

Related U.S. Application Data
(63) Continuation-in-part of application No. 12/265,854, filed on Nov. 6, 2008.
Application No. 12/265,854 is a continuation-in-part of application No. 12/357,046, filed on Jan. 21, 2009.
Application No. 12/357,046 is a continuation-in-part of application No. 11/564,911, filed on Nov. 30, 2006.

(51) Int. Cl. A61C 8/00

(52) U.S. Cl. 433/173

(57) ABSTRACT

A dental implant method and apparatus is disclosed. A dental implant may be placed during one surgery by extracting a tooth from a socket, drilling a hole through crestal bone at the top of the socket, dissecting sinus membrane from the crestal bone by pulsing water through the hole and separating the sinus membrane from the crestal bone, then inserting bone mixture through the hole and between the sinus membrane and the crestal bone to increase the thickness of crestal bone. Then, the hole may be bored to a first diameter and a dental implant having threads and a sidecut may be placed in the hole. After the dental implant is placed, gingival tissue may be vertically translated by dissecting the gingival tissue from alveolar bone near to the socket, making lateral cuts in the gingival tissue on the alveolar bone side of the gingival tissue, and translating the gingival tissue so it is adjacent to the dental implant. In this way, a dental implant may be implanted within one surgery.

### CROSS REFERENCE TO RELATED APPLICATIONS

The present application claims priority to U.S. patent application Ser. No. 12/265,854, filed Nov. 6, 2008, entitled “DRILL FOR RAPID DENTAL IMPLANT”, to U.S. patent application Ser. No. 12/357,046, filed Jan. 1, 2009, entitled “IMPLANT ROOT FOR TOOTH IMPLANTING”, and U.S. patent application Ser. No. 11/564,911, filed Nov. 30, 2006, entitled “IMPLANT ROOT FOR TOOTH IMPLANTING”, the entire contents of each are incorporated herein by reference.

### BACKGROUND

The present invention relates to dental procedures and equipment and more particularly, to a procedure and equipment for lifting a sinus membrane and applying bone graft to a nasal sinus.

Dental implants have become a preferred solution for resolving the problems caused by dentures. Dental implants are made of titanium metal that is of a highly biocompatible material, but does not disintegrate into bio-toxicity while being installed in human bodies. Therefore, the dental implants, with proper surgical procedures, can provide approximately a 90% success rate, as well as improve durability, aesthetics, biting force, prevention of bone loss, etc.

In general, a dental implant is a substitute itself for a lost natural tooth, or a dental operation, in which a screw shape fixture is secured to the jawbone and fused with the jawbone for a predetermined period of time, and then an abutment, i.e. a coupling part, and a prosthesis such as an artificial tooth crown are fixed to the fixture so as to restore the original function of a tooth.

A false tooth or crown is provided with a hole, known as a chimney, there through, and a non-round recess in its base that corresponds in shape to the protruding non-round cross-section of the abutment. Thereby, the crown can be joined to the abutment with a self-aligning connection that prevents relative rotation between them. A screw, passed into the chimney opening, engages the tapped hole in the abutment so as to hold the crown axially to the abutment. Thus, the crown cannot rotate about the abutment because it is fixed into the special contours on the exposed abutment end, and the crown cannot pull away from the abutment when the screw has been tightened in place. Finally, the chimney above the screw is filled with a composite filler material that hardens and is shaped as part of the crown, to look like a natural tooth.

During dental implant placement, an osteotomy is performed to make a proper size round hole on the crestal bone for the installation of an implant. During a conventional osteotomy, different sizes of drills are used to drill a cut hole. This may involve using a round bur for flattening an occlusal surface of the crestal bone and making a location mark for implant, then using a plurality of drills of different diameters to drill a cut hole smaller than the diameter of an implant (for example, if the diameter of an implant is 4.75 mm, the diameter of the drill is 4.25 mM.

After drilling of a cut hole with the plurality of different drills, a countersink drill is then conventionally used to drill the cut hole to the desired diameter equal to a threaded implant, and then a tap is used to tap a thread in the cut hole for the installation of the threaded implant in the crestal bone. Since this conventional cut hole drilling method requires different sizes of drills to be used, operation time and difficulty is increased, thereby lowering the operation success rate.

Furthermore, for posterior positions the sinus floor may be too thin to sufficiently support a conventional implant root. Prior approaches elevate the sinus floor involved creating a window by fracturing part of the skull to gain access to the maxillary sinus. Once the sinus was exposed, a surgeon would then take bone from a patient's hip and graft the bone to the sinus floor. This is considered a major surgery and is performed in a hospital setting under general anesthesia. Also, this process requires a lengthy healing period of 8-12 months. After 8-12 months, a second surgery is then performed to place one or more dental implants in the grafted sinus bone. Then, another 6-9 months is required for healing before final restorations may be placed.

The inventor of the present invention disclosed a dental implant implantation operation for allowing quick implantation of a dental implant without requiring multiple surgeries. To facilitate performance of this quick dental implant implantation operation, the inventor created a number of dental instruments including U.S. application Ser. No. 12/357,046, entitled “Improved implant root for tooth implanting”; U.S. application Ser. No. 12/265,854, entitled “Drill for rapid dental implant”; Taiwan Utility M313502, entitled “Adjustable double blade handle unit”; Taiwan Utility M313504, entitled “Hydraulic pressure type nasal sinus membrane separator”; U.S. application Ser. No. 12/265,012, entitled “Vibrational filling device implanting tooth bone powder”; Taiwan Utility M313506, entitled “Toolset for raising height of nasal sinus.”

### SUMMARY

Accordingly, various embodiments for a dental implant method and apparatus are described below in the Detailed Description. For example, one embodiment comprises drilling a hole through crestal bone at the top of the socket, dissecting sinus membrane from the crestal bone by pulsing water through the hole and separating the sinus membrane from the crestal bone, then inserting bone mixture through the hole and between the sinus membrane and the crestal bone to increase the thickness of crestal bone. Then, the hole may be bored to a first diameter and a dental implant having threads and a sidecut may be placed in the hole. After the dental implant is placed, gingival tissue may be vertically translated by dissecting the gingival tissue from alveolar bone near to the socket, making lateral cuts in the gingival tissue on the alveolar bone side of the gingival tissue, and translating the gingival tissue so it is adjacent to the dental implant. In this way, a dental implant may be implanted within one surgery.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1(A)-(F) is a series of drawings, showing a hydraulic sinus condensing technique to install the dental implant as may be used in a 5-in-1 dental implant procedure.

FIG. 2 is an elevational view of an improved drill for use in installing a dental implant.

FIG. 3 is a perspective view of an improved dental implant.

FIG. 4 is a flow diagram showing a 5-in-1 dental implant procedure.

### DETAILED DESCRIPTION

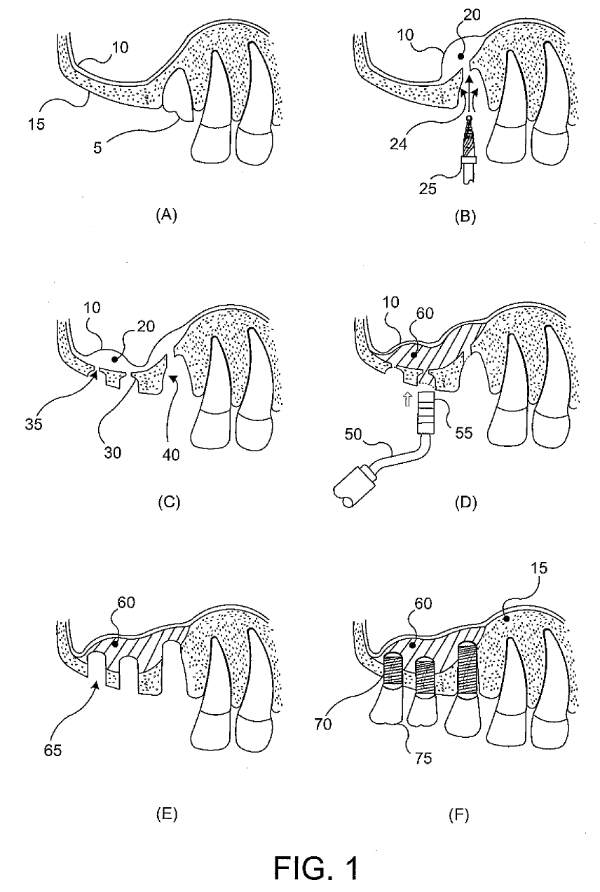

FIG. 1(A)-(F) is a series of drawings, showing a hydraulic sinus condensing technique to install the dental implant as may be used in a 5-in-1 dental implant procedure.

The maxillary sinus has a sinus membrane forming a barrier between the sinus cavity and the surrounding bone. The posterior alveolar bone can be substantially thinner than other portions of crestal bone, thus not supplying enough bone thickness to permanently secure a dental implant. A conventional approach to placing an implant in this thin bone is a sinus lift procedure that involves breaking the bone while hopefully not perforating the membrane, then moving the bone to allow access to the sinus membrane, and then dissecting, or peeling, the membrane from the attached bone. This approach is both invasive, and more involved surgically, and requires additional procedures. FIG. 1 includes an example hydraulic sinus lift procedure that is less invasive and that can also be used in a combination surgery for placing a dental implant.

FIG. 1 (A) illustrates a relatively thin posterior alveolar bone 15, a tooth 5 to be extracted and a sinus membrane 10 in the maxillary sinus and connected to the alveolar bone 15. In this example hydraulic sinus lift, tooth 5 is extracted and any infection at the root of tooth 5 may be cleaned.

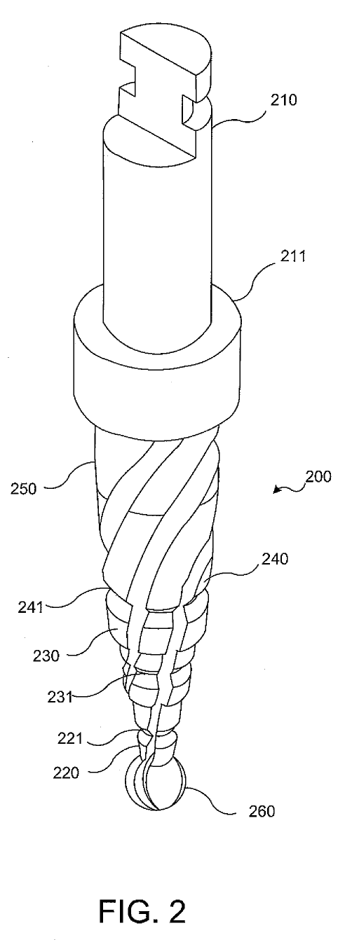

FIG. 1 (B) then illustrates using a combination drill and water jet 25 to provide a stream of pressurized water 24 through a relatively small first hole into the sinus cavity and below the sinus membrane 10. In some embodiments, the stream of pressurized water 24 is supplied in pulses that vary the pressure of the stream and impart a tapping force on the sinus membrane. Additionally, in some embodiments, a stand alone water jet and drill may be used. An example bit for drill 25 is described in more detail with reference to FIG. 2 below. In either of these embodiments, a first hole that accesses the sinus cavity may be created either by mechanically drilling the first hole or by using a water jet of sufficient pressure to perforate the alveolar bone 15. Other embodiments are not so limited and the first hole may be accomplished using other approaches. Additionally, the stream of pressurized water 24 may be other liquids suitable for use in similar dental procedures.

Once a hole is created, the stream of pressurized water 24 imparts a gentle force on the sinus membrane 10 and dissects the sinus membrane 10 from the alveolar bone 15 creating a space 20 between the sinus membrane and bone. In FIG. 1 (B), a curved root socket is illustrated. A bur on the distal end of the bit for drill 25 allows the relatively small first hole to be placed due to a lateral cutting surface on the bur, as will be explained below with reference to FIG. 2 in more detail.

FIG. 1 (C) illustrates two larger bores 30 that were drilled by a larger bur and that may receive additional dental implants. Additionally, a drill or water jet or other device may be used to create a relatively small second or third hole 35 at the tip of the larger bores 30 and the pressurized stream of water 24 may again be used to dissect sinus membrane 10 from bone, similar to as depicted in FIG. 1 (B).

Next, in FIG. 1 (D), a condenser 50 having a condenser tip 55 can be used to place a bone graft 60 into the space between the dissected sinus membrane 10 and the adjacent bone. In a preferred embodiment, the condenser tip 55 has a larger diameter than the first hole, second hole, third hole, etc., and a smaller diameter than the larger bore 30. In this way, bone graft 60 can be condensed into the space 20 using the condenser 50 but while reducing the chance of perforating or damaging the sinus membrane 10. Bone graft 60 may be combinations of bone, may be spongy, or granular. Preferably bone graft 60 that is in contact with sinus membrane 10 is spongy bone to reduce the potential to damage sinus membrane 10.

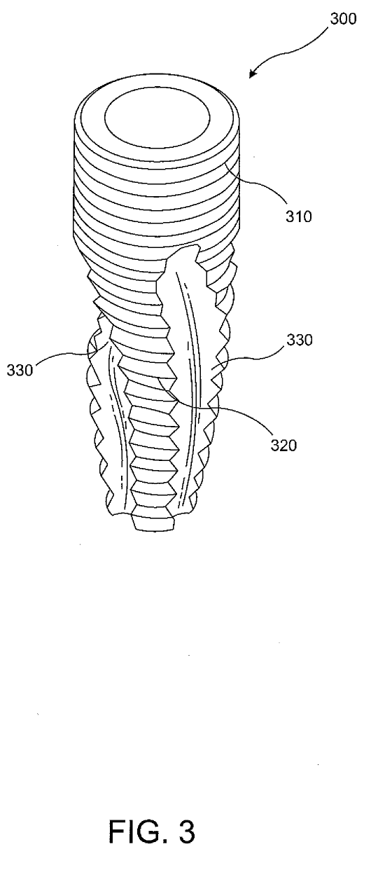

FIG. 1 (E) then illustrates a drilled bore 65 that extends into the bone graft below the sinus membrane and can therefore receive a dental implant 70 as depicted in FIG. 1 (F). Some embodiments of dental implant 70 are described in more detail below with reference to FIG. 3. Generally, the grooved sidecut of dental implant 70 allows sufficient structural support in the relatively thin bone 15 near the implant, allowing the bone graft to form into bone while a temporary crown 75 is placed on implant 70 providing an “immediate load”. In some embodiments, the temporary crown 75 may have a larger occlusal clearance than adjacent natural teeth to not impart too much force through temporary crown 75, dental implant 70, hardening bone graft 60, thin alveolar bone 15, etc.

In some embodiments, a temporary crown 75 may be bonded to an adjacent tooth, or implant, or multiple adjacent teeth or implants, in order to provide more structural rigidity while bone graft transforms to alveolar bone and while Osseo integration takes place with the implant root 70.

FIG. 2 is an elevational view of an improved drill 200 for use in installing a dental implant in the embodiment illustrated in FIG. 1. Drill 200 is shown comprising a connection head 210 configured for quick connection to a dental handpiece, a stop block 211 disposed at the bottom side of the connection head 210, a round bur 260 disposed at the distal end, and a series of active drill body portions 220-250 axially extending upwards from the round bur 260 to the bottom side of the stop block 211 in axial alignment with the connection head 210 in the order from the smallest diameter to the largest diameter in the direction from the round bur 260 toward the connection head 210. The round bur 260 may be used for location marking and to create a crestal bone purchase point to reduce skipping. As a non-limiting example, the round bur 260 may have a thread design that reduces or limits skipping when used on dense cortical bone. The active drill body portions 220-250 may be used for drilling a vertical hole, for example, in the alveolar ridge.

The active drill body portions 220-240 show a conical configuration. A V-grove 221, 231 or 241 is provided around the periphery of the drill 200 between each two adjacent tones of the active drill body portions 220-240 so that the center point is relatively shifted to produce the accurate hole location during drilling. The topmost active drill body portion 250 has a cylindrical shape of uniform diameter. Among the active drill body portions 220-250, the topmost active drill body portion 250 has the largest diameter and length for drilling a hole sufficient for the insertion of a tap (not shown).

In some embodiments, the diameter of the topmost active drill body portion 250 is equal to the diameter of a tap (not shown) so that the drill 200 can drill a cut hole equal to the diameter of a dental implant, and the cut hole can be tapped for the installation of the dental implant.

During an osteotomy, a cut hole is made on the crestal bone with the drill 200, and then the cut hole may be tapped with a tap for direct installation of a dental implant. By means of the application of the drill 200, operation time may be greatly shorted, saving tool component changing time, eliminating potential errors, and raising dental implantation success rates.

FIG. 3 is a perspective view of an improved dental implant 300 having on its upper area a connecting portion 310, the connecting portion 310 having on its outer surface a fine threaded portion, and the implant root 300 having on its lower area a coarse threaded portion 320. The connecting portion 310 may be connected with an abutment of a crown. In some embodiments, the surfaces of the coarse threaded portion 320 have sharp threads that can be implanted in the alveolar bone of a patient by rotation.

A conventional dental implant is designed for healed bone and will not have a threaded surface sufficient to secure to bone that is relatively thin. Therefore, some embodiments may comprise one or more helical treated surfaces 330 (on which cut faces are plane surfaces) that are formed on the coarse threaded portion 320 extending in the vertical direction. In some embodiments, these helical treated surfaces may be treated with roughened coatings, for example, covered with hydroxyapatite coatings. Additionally, some embodiments may have the helical treated surface(s) 330 extending the length of the coarse threaded portion 320. Thereby the areas of the roughened helical treated surfaces 330 are larger than the area of a conventional horizontal treated surface for a dental implant root, and thereby the bone of the implant base can accomplish relatively fast growth to envelop implant root 300.

Furthermore, the roughened helical treated surfaces 330 extending in the vertical direction increase firmness of the implant root 300 implanting into the medullary bone, reducing the time for waiting to mount a crown to the dental implant. And further, if the helical treated surfaces 330 of the coarse threaded portion 320 are extended in the vertical direction, then during implanting the implant root 300 in the alveolar bone any autogenous bone particles during preparation of osteotomy of alveolar bone will stay in the helical treated surfaces 330 and allow smooth insertion of the implant root 300 into bone.

One example embodiment having multiple helical treated surfaces 330 may have three helical treated surfaces 330 laid out in an equiangularly spaced away mode and all extending in the vertical direction. In some embodiments, the three helical treated surfaces may be treated with HA coatings. Additionally, the cut faces on the three helical treated surfaces 330 may be recessed arciform surfaces to further increase the areas of the treated surfaces and the space for retaining autogenous bone particles to provide smooth insertion of the implant root 300 into alveolar bone.

In some embodiments, the connecting portion 310 is provided with a polygonal hole, and a screw hole may be provided in the bottom surface of the polygonal hole. In this way, the polygonal shape of the polygonal hole may be mated with the shape of a connecting section of an abutment so that the abutment can be fast and correctly positioned when in connection with the implant root 300. Then, a bolt on the bottom of the abutment can be smoothly rotated to connect into a screw hole 15 in the inside of implant root 300, thus tightly coupling the abutment to the implant root 300.

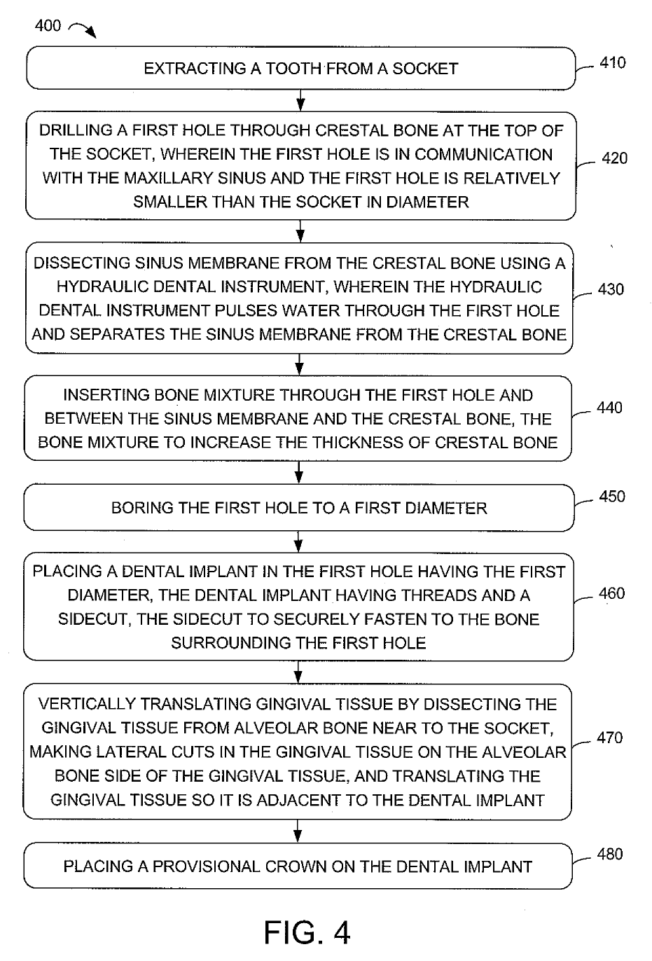

FIG. 4 is a flow diagram showing a method 400 to place dental implant method in one surgery. First, as indicated in block 410, method 400 comprises extracting a tooth from a socket.

Method 400 also comprises drilling a first hole through crestal bone at the top of the socket, wherein the first hole is in communication with the maxillary sinus and the first hole is relatively smaller than the socket in diameter, as indicated in block 420.

Next, method 400 comprises dissecting sinus membrane from the crestal bone using a hydraulic dental instrument. In some embodiments, the hydraulic dental instrument pulses water through the first hole and separates the sinus membrane from the crestal bone, as indicated at 430.

Method 400 also comprises inserting bone mixture through the first hole and between the sinus membrane and the crestal bone, the bone mixture to increase the thickness of crestal bone, as indicated in block 440.

Next, method 400 comprises boring the first hole to a first diameter, as indicated at 450.

Method 400 also comprises placing a dental implant in the first hole having the first diameter, the dental implant having threads and a sidecut, the sidecut to securely fasten to the bone surrounding the first hole, as indicated in block 460. Blocks 410-460 in method 400 may occur in a hydraulic sinus condensing approach as described with reference to FIG. 1, hereinabove.

In some embodiments, method 400 may further comprise bonding the dental implant to at least one of an adjacent tooth or implant for structural support until the bone mixture forms into bone connected with the crestal bone. In yet another embodiment, method 400 may further comprise augmenting a ridge of alveolar bone with bone graft in order to provide more bone surrounding the dental implant.

Next, method 400 comprises vertically translating gingival tissue by dissecting the gingival tissue from alveolar bone near to the socket, making lateral cuts in the gingival tissue on the alveolar bone side of the gingival tissue, and translating the gingival tissue so it is adjacent to the dental implant, as indicated at 470. Method 400 then comprises placing a provisional crown on the dental implant as indicated in block 480.

It will further be understood that the configurations and/or approaches described herein are exemplary in nature, and that these specific embodiments or examples are not to be considered in a limiting sense, because numerous variations are possible. The specific methods described herein may represent one or more of any number of processes. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A method to place a dental implant, comprising:
extracting a tooth from a socket;
drilling a first hole through crestal bone at the top of the socket, wherein the first hole is in communication with the maxillary sinus and the first hole is relatively smaller than the socket in diameter;
dissecting sinus membrane from the crestal bone using a hydraulic dental instrument, wherein the hydraulic dental instrument pulses water through the first hole and separates the sinus membrane from the crestal bone;
inserting bone mixture through the first hole and between the sinus membrane and the crestal bone, the bone mixture to increase the thickness of crestal bone;
boring the first hole to a first diameter;
placing a dental implant in the first hole having the first diameter, the dental implant having threads and a sidecut, the sidecut to securely fasten to the bone surrounding the first hole;
vertically translating gingival tissue by dissecting the gingival tissue from alveolar bone near to the socket, making lateral cuts in the gingival tissue on the alveolar bone side of the gingival tissue, and translating the gingival tissue so it is adjacent to the dental implant; and
placing a provisional crown on the dental implant.

2. The method of claim 1, wherein the first hole is drilled through the crestal bone using a drill with a bur at a distal end and a series of active drill body portions axially extending upwards from the round bur to the bottom side of a stop block and in axial alignment with a connection head in the order from the smallest diameter to the largest diameter.

3. The method of claim 1, further comprising bonding the dental implant to at least one of an adjacent tooth or implant for structural support until the bone mixture forms into bone connected with the crestal bone.

4. The method of claim 1 further comprising augmenting a ridge of alveolar bone with bone graft in order to provide more bone surrounding the dental implant.

5. The method of claim 1 wherein the dental implant has a plurality of sidecuts, each sidecut being a helical groove with a cutting surface, the helical groove having a different slope than the threads on the dental implant.
